(19) United States
(12) Patent Application Publication
(10) Pub. No.: US 2009/0132084 A1
(43) Pub. Date: May 21, 2009

(54) Method of preparing and providing a sticker

(75) Inventors: J. Jeffrey Geldermann, Kenilworth, IL (US); Thomas D. McKechney, Highland Park, IL (US)

Correspondence Address: BRINKS HOFER GILSON & LIONE, P.O. BOX 10395, CHICAGO, IL, 60610, US

(73) Assignee: Credentials Order Processing Services Inc.

(21) Appl. No.: 11/985,752

(22) Filed: Nov. 16, 2007

(51) Int. Cl. G06F 7/00

(52) U.S. Cl. 700/227

(57) ABSTRACT

A method of preparing and providing a sticker is disclosed. In one implementation, a user provides information to a central computer system. The central computer system uses the customer-provided information to prepare an electronic document that is sent to a printer. The electronic document is printed on a mailer blank that includes a sticker. An optional second layer of ink may be applied to the sticker in order to improve legibility of the sticker when it is attached to a windshield. The printed mailer is folded and mailed to the customer.

### BACKGROUND

Parking stickers are issued by cities and colleges to identify vehicles that have been properly registered. The traditional process of issuing parking stickers is time consuming and inefficient.

One commonly employed method of processing a parking sticker request requires an applicant to complete a written form and mail or deliver the form to a clerk's office with the appropriate payment. At the clerk's office, several employees are required to receive the form, process the enclosed payment, select a pre-numbered parking sticker from a stack or sheet of consecutively numbered parking stickers, record the number of the sticker that has been issued to a particular applicant, place the sticker in an envelope, and mail the sticker to the applicant.

This method of processing vehicle identification stickers is labor intensive, inefficient, time consuming, and susceptible to human error. Moreover, cities and colleges generally require a new parking sticker every year, so the inefficiencies of the process described above are repeated regularly or, in the case of colleges, every term or semester. An improved process is needed that makes the overall process more efficient and less expensive.

### SUMMARY OF THE INVENTION

A method of preparing and providing a sticker is provided. A customer provides information and the information is used to prepare an electronic document. The electronic document is sent to a printer where the electronic document is printed on a substrate that includes a sticker. A second layer of ink or a backing member may be applied to the sticker. The substrate may be a mailer that can be folded and mailed to the customer.

### BRIEF DESCRIPTION OF THE DRAWINGS

FIG. 1 is a drawing of a parking sticker that may be created according to the method of the present invention;

FIG. 2 is a drawing of the front side of a mailer blank for use in one embodiment of the present invention;

FIG. 3 is a drawing of the back side of a mailer blank for use in one embodiment of the present invention;

FIG. 4 is a drawing of the front side of a printed mailer blank;

FIG. 5 is a block diagram of one embodiment of the present invention.

FIG. 6 is a cross-section of a UV drier with shield that may be used in one embodiment of the present invention.

### DETAILED DESCRIPTION OF THE DRAWINGS

The present disclosure is directed to methods for preparing and providing a sticker. In one embodiment, the sticker is a vehicle identification sticker such as a parking sticker for a city, college, or the like. It should be understood that while the preferred embodiment of the present disclosure is a parking sticker, the present invention is not limited to parking stickers and it may be used to process other types of stickers as well.

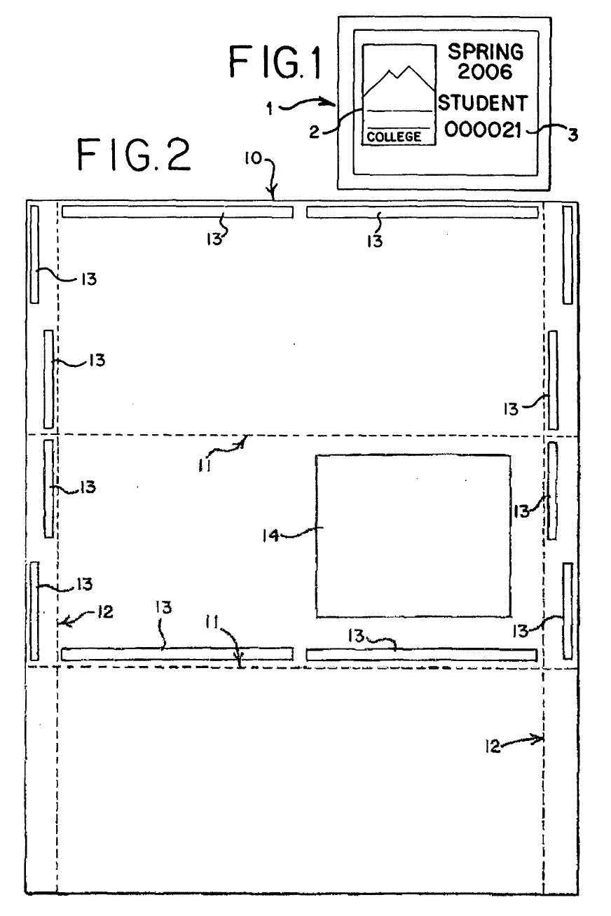

An example of a parking sticker is shown in FIG. 1. A parking sticker 1 generally includes a graphic 2 that identifies the college or town that issued the sticker. A parking sticker 1 also typically includes unique identifying information 3 so that authorities can identify the owner of the sticker. Examples of unique identifying information 3 include a consecutively issued number or the license plate number for the car for which the parking sticker was issued. The sticker may also feature a printed bar code, which contains some of the same information such as the permit number or vehicle license plate.

In one embodiment, a parking sticker is created by printing information on a mailer blank. A mailer blank is a form that may be folded into a size that is appropriate for mailing or sending to a customer through the mail. An example of a mailer blank is described in U.S. Pat. No. 6,095,407, the disclosure of which is incorporated by reference herein. Alternatively, any substrate may be used that includes a sticker. A mailer is preferred because it simplifies the mailing process. However, a substrate other than a mailer may also be used and, if necessary, placed inside an envelope and mailed to the customer.

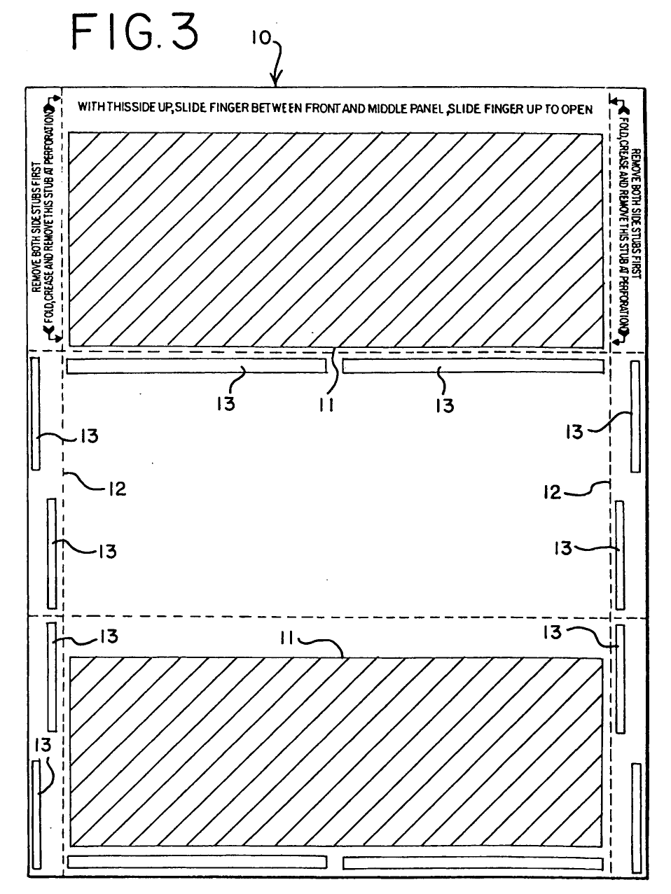

An example of a preferred mailer blank is shown in FIGS. 2 and 3. FIG. 2 shows the front side of the mailer blank. FIG. 3 shows the back side of the mailer blank. The mailer blank 10 includes a paper sheet with a front side and a back side. The mailer blank 10 has two lines of horizontal perforations 11 that divide the mailer into three approximately equal sections. The mailer blank also has vertical perforations 12 along the left and right edges of the mailer blank. The mailer blank has pressure-activated adhesive 13 at appropriate locations on the front side and back side of the mailer.

The mailer blank shown in FIGS. 2 and 3 is configured for use as a Z-fold mailer. However, a C-fold configuration also may be used.

The middle section of the front side of the mailer shown in FIG. 2 includes a sticker 14. The sticker 14 may be any type of sticker that is useful in the present invention. The sticker 14 preferably is made from a clear film. The film may be vinyl, polyester or any other suitable material. The plastic sticker may also be coated with a coating to enhance its performance. For example, the sticker may be print treated with a laser receptive, flexographic coating that helps retain toner during a printing operation.

The sticker may include a conventional adhesive to secure the sticker to the windshield of an automobile. An example of an acceptable conventional adhesive is an acrylic adhesive. Alternatively, the sticker may be a static-cling sticker. Static-cling stickers are shown, for example, in U.S. Pat. Nos. 5,403,025 and 5,334,431. Static-cling stickers adhere to a windshield, but may be detached and reattached repeatedly as desired.

The mailer blank of FIG. 1 also includes a release liner between the sticker and the sheet so that the sticker 14 may be peeled easily from the sheet. An example of an acceptable release liner is a semi-bleached kraft release liner. Alternatively, a release coating may be used in place of the release liner.

Optionally, the sticker may be scored with small cuts. Scoring the sticker makes it difficult to remove the sticker after it is attached to a car windshield. This limits the ability of someone to transfer the sticker to another automobile. Such tamper-proof stickers are desired where sticker theft is a problem or where it is desired to hinder the transfer of stickers between automobiles.

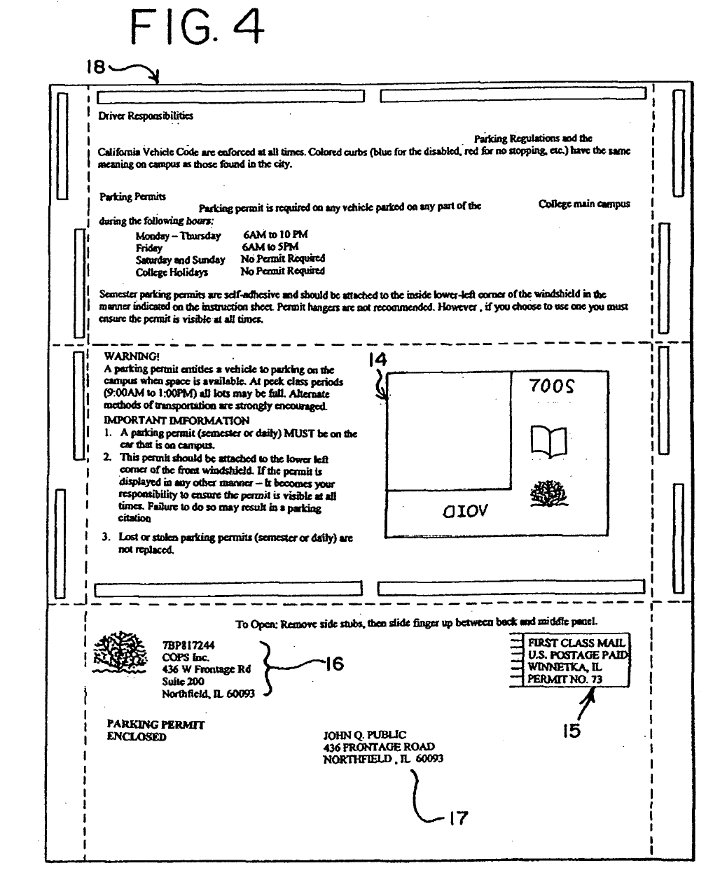

A printed mailer 14 is shown in FIG. 4. The printed mailer may include both general information and customer-specific information. General information may include parking instructions, rules, directions, and regulations. General information also may include a graphic on the sticker that is common to all stickers for a particular city or college. The general information may also include a printed postage stamp 15 or a return address 16. In the embodiment of FIG. 4, instructions, rules, and the like may be printed in the top or middle sections of the front side of the mailer and the postage stamp and other mailing information may be printed on the bottom section of the front side of the mailer.

The printed mailer 14 may also include information that is specific to a particular customer. For example, the mailer may include a customer's name and mailing address 17. The mailer may also include customer-specific information on the sticker. For example, the sticker may include the license plate number for the car being registered or the sticker may include an arbitrary, but consecutively assigned, number to keep track of which sticker is issued to-which customer.

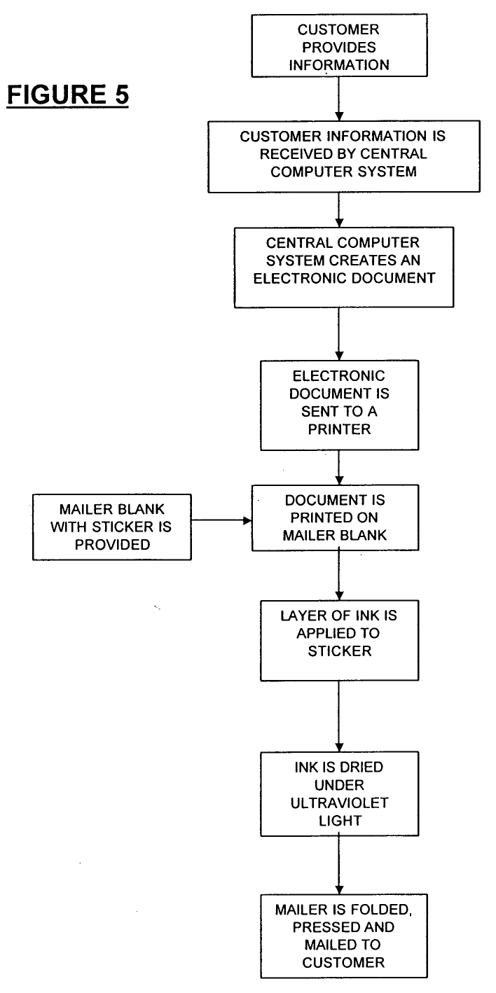

FIG. 5 is a block diagram of one embodiment of a method for processing the sticker and mailer described above. It should be appreciated that the methods described below are not limited to the embodiment of FIG. 5.

The method of FIG. 5 will now be described in greater detail. A customer provides information that is necessary to process the request for a parking sticker. Preferably, the customer provides the information through a secure internet website. A website may be provided that allows the user to input information that is necessary to process the request. Alternatively, the information may be provided over any type of wide area network (WAN) or local area network (LAN). Information that is provided by the customer may include the customer's name, address, type of car, license plate number, vehicle year, vehicle color and/or payment information.

If a customer does not have access to the internet or other network, the customer may go to a specified office where a computer is provided with access to the internet or an appropriate network. The customer may then enter his or her information using the provided computer. As a further alternative, a customer may fill out a form and bring the form, or mail the form, to an office for an employee to enter the information manually.

The information provided by the customer may be stored and processed by a central computer system. The central computer system may be implemented as hardware, firmware, and/or software code running in conjunction with a processor such as a single server, a plurality of servers, or any other computing device known in the art. The central computer system is capable of processing the information provided by the customer and facilitating the printing of the sticker.

In a preferred embodiment, the central computer system creates one or more electronic documents that include the information and graphics that must be printed on the mailer blank 10 in order to create the finished mailer 18. The electronic document may be in any format that is appropriate for printing. In one embodiment, the electronic document exists in Portable Document Format (i.e., .pdf).

The central computer system selects the general information that is to be included in the electronic document based on the information entered by the customer. For example, if the customer enters information indicating that she is requesting a sticker for a student at a particular college, the central computer system creates an electronic document that includes the general information for parking stickers that are issued to students at that college. The central computer system then adds the customer-specific information to the electronic document. Such information may include the customer's name, mailing addressing and/or a unique identifier for the sticker.

In one embodiment, templates are stored on the central computer system for each of the various cities or colleges. In order to create the electronic document, the central computer system selects the appropriate template based on the information entered by the customer. For example, if information was provided over a website, the website may ask the customer to indicate which sticker she is requesting. The sticker selected by the customer dictates which template the central computer system should use.

Alternatively, the user may have landed on the sticker-processing website as a result of being redirected from a college or city website. In being redirected, a packet of information may accompany the user that automatically informs the sticker-processing website and/or central computer system which sticker the customer is requesting or whether the customer has qualified for a discounted fee.

The template includes blanks for the customer-specific information. The central computer system then fills in the blanks with information entered by the customer or information that has been derived from the information entered by the customer in order to complete the electronic document.

In creating the electronic document, it may be necessary to format the information and graphics that are to be printed on the sticker so that they are printed on the sticker as a mirror-image. For example, in the embodiment of FIG. 1, the adhesive side of the sticker faces down and the ink is applied to the “back” of the sticker. In order to make the sticker legible when it is applied to the inside of a windshield, the information must be printed on the back of the sticker (the non-adhesive side) as a mirror-image.

The central computer system may also perform several optional tasks. For example, where the requested parking sticker is a city-issued sticker for residents only, the central computer system may be used to validate the address provided by the customer and confirm that the customer lives in the required city. Similarly, if a parking sticker is a college-issued sticker for students or faculty only, the central computer system may be used to confirm that the customer is entitled to a sticker by comparing the customer's name or address to a list of customers that have been pre-approved to receive a sticker.

Alternatively, customer validation may be performed before the information is received by the central computer system. For example, if a customer requests a sticker through an internet website, the website may require the customer to log-in using a password or unique self-validating information.

The central computer system may also be used to process payment for the parking sticker. If the customer provides a credit card number with his or her application, the central computer system may be used to process the credit card transaction and facilitate payment for the parking sticker.

The completed electronic document is sent to a printer to create, for example, a mailer such as the mailer shown in FIG. 4. The electronic document may be sent to the printer individually or several electronic documents may be held in reserve in a special file and then spooled to the printer as a group at the appropriate time. In one embodiment, an IBM INFOPRINT server is used to control the printing operation.

In a preferred embodiment, the mailers are printed in groups according to the destination address. The central computer system may be used to establish the print queue according the customer's address and control the order in which the mailers are printed. When the electronic documents are printed according to these pre-sorted print groups, the resulting mailers are pre-sorted by address and qualify for the lower postage rates applicable to pre-sorted mail.

The printer may be any printer capable of putting information or images on a document. In a preferred embodiment, the printer is a CANON C5180 laser printer. The printing method, however, does not limit the scope of the present invention. For example, any number of printing techniques, including thermal transfer, ink jet, laser, LED, dye sublimation or impact printing are acceptable. In one embodiment, the ink has a low wax content, preferably between 5-15%.

The printed mailer may be sent to a second printing operation. In an optional second printing operation, a second layer of ink is applied to the sticker portion of the mailer. Depending on the design applied to the sticker and the process chosen to print the mailer, the sticker that results from the first printing operation may be unacceptably translucent when attached to a windshield. As a result, it is difficult to see the information on the sticker through a windshield. A second layer of ink acts as a background for the image to make it easier to read the information on the sticker.

In one embodiment, the second layer of ink is applied with a screen printing press. A screen printing press that may be used in the methods of the present invention is available from BecMar Corporation under the trade name GENERAL PONY EXPRESS printer. Documents may be fed to the printer using a GENERAL MASTERFEED document feeder. In one embodiment, the screen in the screen printing press has a mesh of 305 threads/inch.

The second layer of ink is preferably a color and type of ink that makes it easier to view information printed on the sticker through the windshield. In a preferred embodiment, the second layer of ink is white and ultraviolet curable. The ink is commercially available under the trade name VYW-W70 from Sun Chemical. Ultraviolet curable inks are preferred because of their quick drying time. Driers for curing the ink with ultraviolet light are commercially available, for example, from American Ultraviolet Company. The present invention, however, is not limited to UV curable inks. Other inks, such as solvent based inks, may also be used.

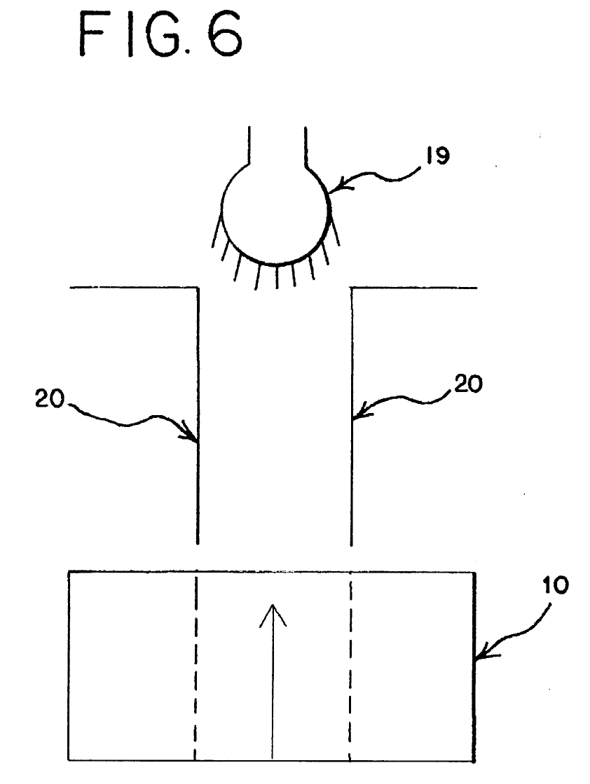

If ultraviolet light is used to dry the second layer of ink on a mailer that includes pressure activated adhesive, it may be necessary to take precautions to protect at least some of the pressure-activated adhesive on the mailer from the ultraviolet light. This is because some pressure-activated adhesives are rendered ineffective if exposed to ultraviolet light. For this reason, a shield may be used when curing the ink with the ultraviolet light. An example of an acceptable shielding apparatus is shown in FIG. 6. FIG. 6 is a cross-sectional view of a UV drier where the mailer 10 is being fed though the drier in the direction of the z-axis. Ultraviolet light bulb 19 shines UV light onto the form 10. The shield consists of two metal plates 20 that prevent the UV light from spreading to the top and bottom portions of the form. Instead, the UV light is confined to the middle third of the form that includes the sticker and UV curable ink. The shield allows the ultraviolet light to contact the ink on the sticker, but prevents the ultraviolet light from contacting other parts of the mailer.

Alternatively, instead of or in addition to a second layer of ink, a backing member may be applied to the back of the sticker. The backing member is opaque and acts as a background to make it easier to read the information on the sticker. The backing member may be made of any acceptable material, such as polyester, and may be secured to the sticker with an acceptable adhesive, such as an acrylic adhesive. The backing member may be applied to static cling stickers or traditional adhesive stickers. The backing member may be applied to the sticker using conventional labeling technology. The backing member not only makes the information on the sticker easier to read, but it also makes the sticker more resistant to tearing.

After the mailer is printed and cured, the printed mailer may be fed to a stacker such as the GENERAL STACKMASTER. The printed mailer may then be folded and compressed to activate the pressure-activated adhesive. Machines are available that automatically stack, fold and compress the finished mailers. Acceptable folding and sealing machines are commercially available from VERSASEAL.

The finished mailers are then put in the mail and sent to the customers and/or end-users. The customers and/or end-users receive the mailers, remove the parking sticker from the mailer, and apply the printed stickers to the windshield of their automobile.

It is intended that the foregoing detailed description be regarded as illustrative rather than limiting, and that it be understood that it is the following claims, including all equivalents, that are intended to define the spirit and scope of this invention.

1. A method of preparing a sticker, the method comprising the steps of:
a. receiving information from a customer;
b. using the information to prepare an electronic document;
c. sending the electronic document to a printer;
d. providing a substrate, the substrate including a sticker;
e. printing the electronic document on the substrate; and
f. applying a layer of ink over the sticker.

2. The method of claim 1, wherein the substrate is a mailer blank.

3. The method of claim 1 wherein the information is received from the customer through an internet website.

4. The method of claim 1, wherein the information from the customer includes payment information and the method further comprises the step of using the payment information to process payment for the sticker.

5. The method of claim 1, further comprising the step of curing the layer of ink with ultraviolet light.

6. The method of claim 5, further comprising the step of protecting at least a portion of the mailer from the ultraviolet light.

7. A method of preparing a sticker, the method comprising the steps of:
a. receiving information from a customer;
b. using the information to prepare an electronic document;
c. sending the electronic document to a printer;
d. providing a mailer blank, the mailer blank including a sticker;
e. printing the electronic document on the mailer blank;
f. folding the printed mailer; and
g. mailing the printed mailer to the customer.

8. The method of claim 7, further comprising the step of applying a layer of ink to the sticker after printing the electronic document.

9. The method of claim 7, further comprising the step of applying a backing member to the sticker after printing the electronic document.

10. The method of claim 8, further comprising the step of curing the layer of ink with ultraviolet light.

11. The method of claim 10, further comprising the step of protecting at least a portion of the mailer from ultraviolet light.

12. The method of claim 7 wherein the information is received from the customer through an internet website.

13. A method of providing a plurality of stickers, the method comprising the steps of:
a. receiving information from a plurality of customers;
b. using the information to prepare a plurality of electronic documents;
c. sending the electronic documents to a printer;
d. providing substrates, the substrates each including a sticker;
e. printing the electronic documents on the substrates; and
f. applying a layer of ink over the stickers.

14. The method of claim 13, wherein the information from the customers includes a mailing address, and the method further comprises the step of sorting the electronic documents into groups according to the mailing addresses entered by the customers.

15. The method of claim 13, wherein the substrate is a mailer blank.

16. The method of claim 15, further comprising the step of folding the mailer and mailing it to the customer.

17. The method of claim 13, wherein the information is received from the plurality of customers through an internet web site.

18. A method of preparing a sticker, the method comprising the steps of:
a. receiving information from a customer;
b. using the information to prepare an electronic document;
c. sending the electronic document to a printer;
d. providing a substrate, the substrate including a sticker, the sticker having a back side;
e. printing the electronic document on the substrate; and
f. applying a backing member to the back side of the sticker.

19. A method of providing vehicle identification stickers to a plurality of customers, the method comprising the steps of:
a. providing a central computer system;
b. receiving information from each customer;
c. storing the information on the central computer system;
d. using the central computer system to prepare electronic documents using the information provided by each customer;
e. sending the electronic documents to a printer;
f. providing mailer blanks, the mailer blanks including a sticker;
g. printing the electronic documents on the mailer blanks;
h. applying a layer of ink over each sticker;
i. folding the printed mailer; and
j. mailing the printed mailer to the customer.
